(19) United States
(12) Patent Application Publication
(10) Pub. No.: US 2025/0319381 A1
(43) Pub. Date: Oct. 16, 2025

(54) MACHINE LEARNING TECHNIQUES FOR PREDICTION OF ONE-ON-ONE PASS RUSH AND PROTECTION

(71) Applicant: STATS LLC, Chicago, IL (US)

(72) Inventors: Kyle Banitu Cunningham-Rhoads, Corvallis, OR (US); Gregory Michael Gifford, Arlington Heights, IL (US)

(73) Assignee: STATS LLC, Chicago, IL (US)

(21) Appl. No.: 19/173,147

(22) Filed: Apr. 8, 2025

Related U.S. Application Data
(60) Provisional application No. 63/632,772, filed on Apr. 11, 2024.

(51) Int. Cl. A63B 71/06

(52) U.S. Cl. CPC A63B 71/0616; A63B 2243/007

(57) ABSTRACT

A method for using machine learning to predict a success of a matchup in a sporting event, the method including accessing tracking data from a data store; identifying, from the tracking data, one or more matchups wherein each matchup includes an identification of a first player, an identification of a second player, and a success of a corresponding outcome; filtering the identified matchups to create a subset of matchups; providing the subset of matchups to a trained machine learning model; receiving, from the machine learning model, a prediction of success of the matchup; comparing the prediction of success with a measured outcome; and adjusting a ranking of the first player, a ranking of the second player, and/or the machine learning model based on the prediction.

### CROSS-REFERENCE TO RELATED APPLICATIONS

This application claims priority under 35 U.S.C. § 119 (e) to Provisional U.S. Patent Application No. 63/632,772, filed Apr. 11, 2024, the disclosure of which is hereby incorporated by reference in its entirety.

### TECHNICAL FIELD

Various aspects of the present disclosure relate generally to machine learning for sports applications, and in particular, various aspects relate to machine learning techniques for analyzing one or more plays in American football.

### BACKGROUND

Unless otherwise indicated herein, the materials described in this section are not prior art to the claims in this application and are not admitted to be prior art, or suggestions of the prior art, by inclusion in this section.

In American football, a pass rush is an attempt by one or more defensive players to prevent a pass by charging toward the quarterback at the line of scrimmage. Some metrics exist for evaluating pass rush production such as pressure and pressure rate. But these metrics suffer from various deficiencies.

Disclosed solutions use machine learning techniques to address these deficiencies.

### SUMMARY OF THE DISCLOSURE

In some aspects, the techniques described herein relate to using machine learning for sports applications. In an aspect, disclosed techniques include a method for using machine learning to predict a success of a matchup in a sporting event, the method comprising: accessing tracking data from a data store; identifying, from the tracking data, one or more matchups wherein each matchup comprises an identification of a first player, an identification of a second player, and a success of a corresponding outcome; filtering the identified matchups to create a subset of matchups; providing the subset of matchups to a trained machine learning model; receiving, from the machine learning model, a prediction of success of the matchup; comparing the prediction of success with a measured outcome; and adjusting a ranking of the first player, a ranking of the second player, and/or the machine learning model based on the prediction.

In another aspect, disclosed techniques include a non-transitory computer readable medium having a sequence of instructions, which, when executed by a processor, causes a computing system to perform operations comprising: accessing, by the computing system, tracking data from a data store; identifying, via the computing system from the tracking data, one or more matchups wherein each matchup comprises an identification of a first player, an identification of a second player, and a success of a corresponding outcome; filtering, by the computing system, the identified matchups to create a subset of matchups; providing, by the computing system, the subset of matchups to a trained machine learning model; receiving, by the computing system from the machine learning model, a prediction of success of the matchup; comparing, by the computing system, the prediction of success with a measured outcome; and adjusting, by the computing system, a ranking of the first player, a ranking of the second player, and/or the machine learning model based on the prediction.

In another aspect, disclosed techniques include a computing system comprising: a processor implemented in hardware; and a memory having programming instructions stored thereon, which, when executed by the processor, causes the system to perform operations comprising: accessing tracking data from a data store; identifying, from the tracking data, one or more matchups wherein each matchup comprises an identification of a first player, an identification of a second player, and a success of a corresponding outcome; filtering the identified matchups to create a subset of matchups; providing the subset of matchups to a trained machine learning model; receiving, from the machine learning model, a prediction of success of the matchup; comparing the prediction of success with a measured outcome; and adjusting a ranking of the first player, a ranking of the second player, and/or the machine learning model based on the prediction.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 is a block diagram of an exemplary tracking and analytics environment, in accordance with an aspect of the disclosed subject matter.

FIG. 2 is a flow diagram of an exemplary method for using machine learning models to predict a success of a matchup in a sporting event, in accordance with an aspect of the disclosed subject matter.

FIG. 3 is a block diagram illustrating a transfer portal, in accordance with an aspect of the disclosed subject matter.

FIG. 4 is a flow diagram for training a machine learning model, in accordance with an aspect of the disclosed subject matter.

FIG. 5 is a flow diagram of an exemplary method for using machine learning models to predict success of a player on a new team, in accordance with an aspect of the disclosed subject matter.

FIG. 6 is an example of a computing device, in accordance with an aspect of the disclosed subject matter.

Notably, for simplicity and clarity of illustration, certain aspects of the figures depict the general configuration of the various aspects. Descriptions and details of well-known features and techniques may be omitted to avoid unnecessarily obscuring other features. Elements in the figures are not necessarily drawn to scale; the dimensions of some features may be exaggerated relative to other elements to improve understanding of the example aspects.

### DETAILED DESCRIPTION OF ASPECTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various aspects of the present disclosure relate to machine learning for sports applications. For instance, disclosed solutions use machine learning in conjunction with generating and/or analyzing improved datasets to generate improved metrics or ratings for pass rush attempts (and pass protection) in sports such as American football.

As discussed above, existing solutions suffer from deficiencies. For example, in the past, various metrics were used such as counting statistics, sacks, pressures, tackles for loss, rate statistics, and pressure rate. But these metrics are incomplete representations of pass rush attempts. For instance, a measurement of sacks, when the quarterback is tackled behind the line of scrimmage before throwing a forward pass, is not a representative metric due to a shortage of data. For instance, at best, even top players may only perform one sack per game.

Other existing metrics measure a result against an opportunity. But an opportunity may mean different underlying statistics such as total pass snaps played, total pass rushes, or total pass rushes in “true pass sets” (e.g., without run pass options or RPOs). Therefore, this approach may lead to ambiguous data. For example, these metrics may still consider a player who is double teamed by multiple offensive players to have the same result-opportunity as a player who gets a one-on-one matchup or even a free rush at the quarterback.

Other existing metrics may evaluate successful pass rush attempts based on how the attempt impacts the quarterback. But while in many cases a true pass rush win will affect the quarterback, this is not always the case. Yet other existing metrics may assume that all pass rush attempts are the same and of equal measurement. For example, an opportunity where a player who is double-teamed by the offense should not be considered the same quality of opportunity as a player who gets a free rush with no offensive blockers. Such metrics also do not account for the strength of matchup.

Disclosed solutions solve these deficiencies. In an example, a system assigns an initial rating to each player at the start of a season. As the season progresses, the system accesses datasets corresponding to football games that take place. The system then identifies, from the datasets, matchups between pass rushers and pass blockers from each passing play. The system filters the matchups to include only those which are a true one-on-one matchup with sufficient time to run the matchup to completion. For example, for a matchup to count, a quarterback must have enough time in the pocket for the pass rusher and pass protector to complete their matchup.

Continuing the example, the filtered matchups are provided to a machine learning model, which predicts a likelihood of success of the matchup, specifically, whether the pass rush will succeed. The prediction is compared with an actual outcome of the matchup, e.g., from the original datasets, and the model is updated accordingly. The model outputs an updated ranking. This process continues as more plays and matchups are available.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity. Further, while various aspects of American football (e.g., pass rushes) are described in the present aspects as illustrative examples, the present aspects are not limited to such examples. For example, the present aspects can be implemented for other sports or activities, such as basketball, baseball, and so forth.

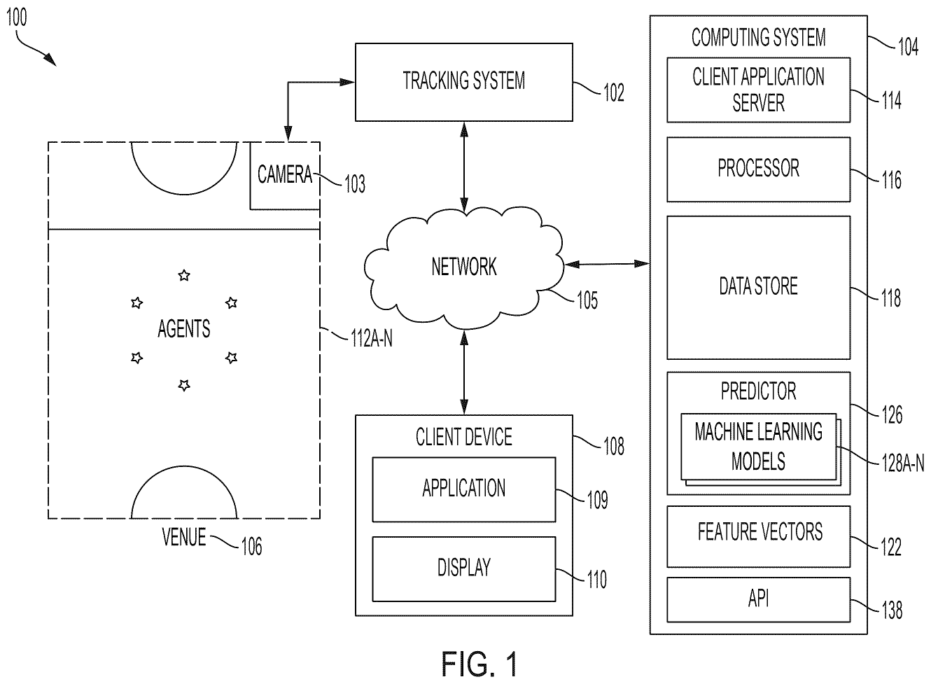

FIG. 1 is a block diagram illustrating a tracking and analytics environment 100, according to example aspects. Environment 100 includes tracking system 102, computing system 104, and client device 108 connected via network 105. In the example depicted, tracking system 102 obtains various measurements of game play, and transmits the measurements across network 105 to computing system 104, where the measurements can be used in conjunction with one or more machine learning models.

Tracking system 102 is positioned in, adjacent to, or near a venue 106. Non-limiting examples of venue 106 include stadiums, fields, pitches, and courts. Venue 106 includes agents 112A-N (players). Tracking system 102 may be configured to record the motions and actions of agents 112A-N on the playing surface, as well as one or more other objects of relevance (e.g., ball, referees, etc.).

In some aspects, tracking system 102 may be an optically-based system using, for example, using camera 103. While one camera is depicted, additional cameras are possible. For example, a system of six stationary, calibrated cameras, which project the three-dimensional locations of players and the ball onto a two-dimensional overhead view of the court may be used. Although environment 100 depicts agents 112A-N generally as players, it will be understood that in accordance with certain implementations, agents 112A-N may correspond to players, objects, markers, and/or the like.

In some aspects, tracking system 102 may be an optically-based system using, for example, camera 103. While one camera is depicted, additional cameras are possible. For example, a system of six stationary, calibrated cameras, which project the three-dimensional locations of players and the ball onto a two-dimensional overhead view of the court may be used.

In another example, a mix of stationary and non-stationary cameras may be used to capture motions of all agents 112A-N on the playing surface as well as one or more objects or relevance. Utilization of such tracking system (e.g., tracking system 102) may result in many different camera views of the court (e.g., high sideline view, free-throw line view, huddle view, face-off view, end zone view, etc.). In some aspects, tracking system 102 may be used for a broadcast feed of a given match. In such aspects, each frame of the broadcast feed may be stored in a game file. In some aspects, the game file may further be augmented with other event information corresponding to event data, such as, but not limited to, game event information (pass, made shot, turnover, etc.) and context information (current score, time remaining, etc.).

In some aspects, a game file may include ratings data, standings data, statistics, and/or odds. In some aspects, a game file may include one or more match data types. A match data type may include, but is not limited to, position data (e.g., player position, object position, etc.) change data (e.g., changes in position, changes in players, changes in objects, etc.), trend data (e.g., player trends, position trends, object trends, team trends, etc.), play data, etc. A game file may be a single game file or may be segmented (e.g., grouped by one or more data type, grouped by one or more players, grouped by one or more teams, etc.).

In some embodiments, tracking system 102 may be used for a broadcast feed of a given match. For example, tracking system 102 may be used to generate game files to facilitate a broadcast feed of a given match. In such embodiments, each frame of the broadcast feed may be stored in a game file. A broadcast feed may be a feed that is formatted to be broadcast over one or more channels (e.g., broadcast channels, internet based channels, etc.). A game file may be converted from a first format (e.g., a format output by the one or more cameras or a different format than the format output by the one or more cameras) and may be converted into a second format (e.g., for broadcast transmission).

In some embodiments, game file may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine learning trained to receive, as an input, a game file or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post or an endzone). Based on such determination, an event type of a goal scored may be identified. Further, the digital representation of the player(s) that contacted the object (e.g., ball) prior to the goal scored event may be identified as the player(s) that contributed to or otherwise caused the event (e.g., a score). Accordingly, content feeds may be used to generate tracking data which may further be used to determine event data corresponding to certain sports events. The tracking data and/or event data may be used to generate game previews/game summaries as disclosed herein.

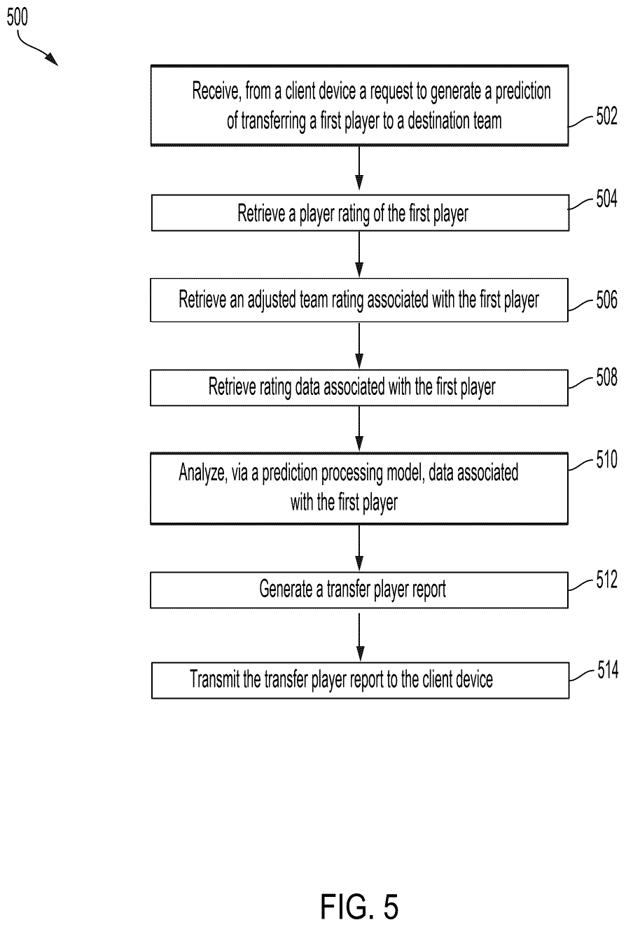

Tracking system 102 may be configured to communicate with computing system 104 via network 105. Computing system 104 may be configured to manage and analyze the data captured by tracking system 102. Computing system 104 may include a web client application server 114, a pre-processing agent 116, a data store 118, and a third-party Application Programming Interface (API) 138. An example of computing system 104 is depicted with respect to FIG. 5. Pre-processing agent (processor) 116 may be configured to process data retrieved from data store 118 or tracking system 102 prior to input to predictor 126. In some examples, tracking system 102 may be configured to provide computing system 104 with a broadcast stream of a game or event in real-time or near real-time via network 105. As an example, tracking system 102 may provide one or more game files in a first format (e.g., corresponding to a format based on the components of tracking system 102). Alternatively, or in addition, tracking system 102 or organization computing system 104 may convert the broadcast stream (e.g., game files) into a second format, from the first format. The second format may be based on the computing system 104. For example, the second format may be a format associated with data store 118, discussed further herein.

Computing system 104 may be configured to process the broadcast stream of the game. Organization computing system 104 may include components shown in FIG. 1, as described herein, as well as one or more of a tracking data system, a play-by-play module, and/or padding module. A tracking data system, play-by-play module, padding module, and prediction system (including predictor 126) may be comprised of one or more software modules. The one or more software modules may be collections of code or instructions stored on a media (e.g., memory of computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

The tracking data system may be configured to receive broadcast data from tracking system 102 and generate tracking data from the broadcast data. In some embodiments, the tracking data system may apply an artificial intelligence and/or computer vision system configured to derive player-tracking data from broadcast video feeds.

To generate the tracking data from the broadcast data, the tracking data system may, for example, map pixels corresponding to each player and ball to dots and may transform the dots to a semantically meaningful event layer, which may be used to describe player attributes. For example, the tracking data system may be configured to ingest broadcast video received from tracking system 102. In some embodiments, the tracking data system may further categorize each frame of the broadcast video into trackable and non-trackable clips. In some embodiments, the tracking data system may further calibrate the moving camera based on the trackable and non-trackable clips. In some embodiments, the tracking data system may further detect players within each frame using skeleton tracking. In some embodiments, the tracking data system may further track and re-identify players over time. For example, the tracking data system may reidentify players who are not within a line of sight of a camera during a given frame. In some embodiments, the tracking data system may further detect and track an object across a plurality of frames. In some embodiments, the tracking data system may further utilize optical character recognition techniques. For example, the tracking data system may utilize optical character recognition techniques to extract score information and time remaining information from a digital scoreboard of each frame.

Such techniques assist in the tracking data system generating tracking data from the broadcast feed (e.g., broadcast video data). For example, the tracking data system may perform such processes to generate tracking data across thousands of possessions and/or broadcast frames. In addition to such process, computing system 104 may go beyond the generation of tracking data from broadcast video data. Instead, to provide descriptive analytics, as well as a useful feature representation for the prediction system, computing system 104 may be configured to map the tracking data to a semantic layer (e.g., events).

The tracking data system may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

A play-by-play module may be configured to receive play-by-play data from one or more third party systems. For example, the play-by-play module may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, the play-by-play module may utilize machine learning outputs and/or manually annotated data that may reflect the referee's ultimate adjudication. Such data may be referred to as the play-by-play feed.

To help identify events within the generated tracking data, the tracking data system may merge or align the play-by-play data with the raw generated tracking data (which may include the game and time fields). The tracking data system may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, the tracking data system may be configured to perform various operations on the aligned tracking system. For example, the tracking data system may use the play-by-play data to refine the player and ball positions and precise frame of the end of possession events (e.g., shot/rebound location). In some embodiments, the tracking data system may further be configured to detect events, automatically, from the tracking data. In some embodiments, the tracking data system may further be configured to enhance the events with contextual information.

For automatic event detection, the tracking data system may include a neural network system trained to detect/refine various events in a sequential manner. For example, the tracking data system may include an actor-action attention neural network system to detect/refine one or more of: shots, scores, points, rebounds, passes, dribbles, penalties, fouls, and/or possessions. The tracking data system may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, the tracking data system may generate contextual information to enhance the detected events. Exemplary contextual information may include defensive matchup information (e.g., who is guarding who at each frame, defensive formations), as well as other defensive information such as coverages for ball-screens or presses.

As discussed herein, disclosed solutions leverage delay data to predict stoppage time. Delay data may be determined and/or received from an external device. For instance, occurrences of events during a match (e.g., a goal, or an assist), may be determined by tracking system 102 and stored in data store 118. Such a determination may be made based on a video stream such as a broadcast video stream (e.g., via TV or streaming) and/or an in-venue feed. In turn, the information is analyzed to determine an occurrence of an event and a type of event.

In some cases, a data stream prepared by a human observer may be used. For instance, a human observer may record when a goal occurs, and information such as the event type and time stamp (e.g., minutes into the game) may be entered into a data stream that is in turn used by systems disclosed herein.

Pre-processing agent 116 may be configured to process data retrieved from data store 118 or tracking system 102 prior to input to predictor 126.

Data store 118 may be configured to store different kinds of data. In an example, data store 118 can store raw tracking data received from tracking system 102. The data store 118 can include historical game data, live data, features, and one or more predictions. The historical game data may include historical team and player data for one or more sporting events. The live data can include data received from tracking system 102, e.g., in real time. Data store 118 may also store matchup information, which may include identifiers of players who are matched up and whether the matchup was successful. The historical game data can include historical team and player data for one or more sporting events. Live data can include data received from tracking system 102, e.g., in real time. Data store 118 may be configured to store one or more game files. Each game file may include video data of a given match (e.g., a game, a competition, a round, etc.) and/or may include tracking data generated by tracking system 102 or in response to data generated by tracking system 102. Video data may correspond to data for an ongoing match or data for a previous or historical match. For example, the video data may correspond to video frames captured by tracking system 102 (e.g., as a broadcast feed, an in-venue feed, etc.). In some aspects, the video data may correspond to broadcast data of a given match, in which case, the video data may correspond to video frames of the broadcast feed of a given match.

The feature vectors 122 can be generated for a specific sporting event, matchups, plays, or a combination thereof. Feature vectors 122 can include player and/or team features. For instance, feature vectors 122 may include locations of players on a football field, their movement, speed, starting point, and/or destination.

Predictor 126 includes one or more machine-learning models 128A-N. As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration. Machine learning models 128A-N may be neural networks. In some cases, one or more of the machine learning models 128A-N are remotely hosted, for example on a remote server. Machine learning models 128A-N can be generative machine learning models.

In some cases, the machine learning models 128A-N require input of a prompt. As such, computing system 104 and/or predictor 126 can generate one or more prompts such that the output of the model is aligned with the request, query, or information included in the prompt. A prompt can include instructions to the model (e.g., task(s) to be performed, and style of output), data to be used (e.g., data from a particular team or a player), and/or any user preferences (e.g., style, tone, or length).

The execution of the machine learning model may include deployment of one or more machine learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

Client device 108 may be in communication with computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with computing system 104, such as individuals who have obtained, will obtain, or may obtain a product, service, or consultation from an entity associated with computing system 104.

Client device 108 may include one or more applications 109. Application 109 may be representative of a web browser that allows access to a website or a stand-alone application. Client device 108 may access application 109 to access one or more functionalities of computing system 104. Client device 108 may communicate over network 105 to request a webpage, for example, from web client application server 114 of computing system 104. For example, client device 108 may be configured to execute application 109 to access content managed by web client application server 114. The content that is displayed to client device 108 may be transmitted from web client application server 114 to client device 108, and subsequently processed by application 109 for display through a graphical user interface (GUI) of client device 108.

Client device 108 may include display 110. Examples of display 110 include, but are not limited to, computer displays, Light Emitting Diode (LED) displays, and so forth. Output or visualizations generated by application 109 can be displayed on display 110.

Functionality of sub-components illustrated within computing system 104 can be implemented in hardware, software, or some combination thereof. For example, software components may be collections of code or instructions stored on a media such as a non-transitory computer-readable medium (e.g., memory of computing system 104) that represent a series of machine instructions (e.g., program code) that implements one or more method operations. Such machine instructions may be the actual computer code the processor of computing system 104 interprets to implement the instructions or, alternatively, may be a higher level of coding of the instructions that is interpreted to obtain the actual computer code. The one or more software modules may also include one or more hardware components. Examples of components include processors, controllers, signal processors, neural network processors, and so forth.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security. Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Aspects of the present disclosure relate to sports analytics using machine learning. For instance, certain aspects use machine learning in conjunction with improved datasets to generate improved metrics for pass rush attempts (defensive players) and pass protection (offensive players) in football.

Disclosed techniques may be used to analyze pass rushing and pass protection talent sports leagues such as across National Football League (NFL), Amateur football leagues, etc. More specifically, disclosed systems can determine a best pass rusher and a best pass protector by using machine learning to determine differences in quality of opportunity and quality of competition.

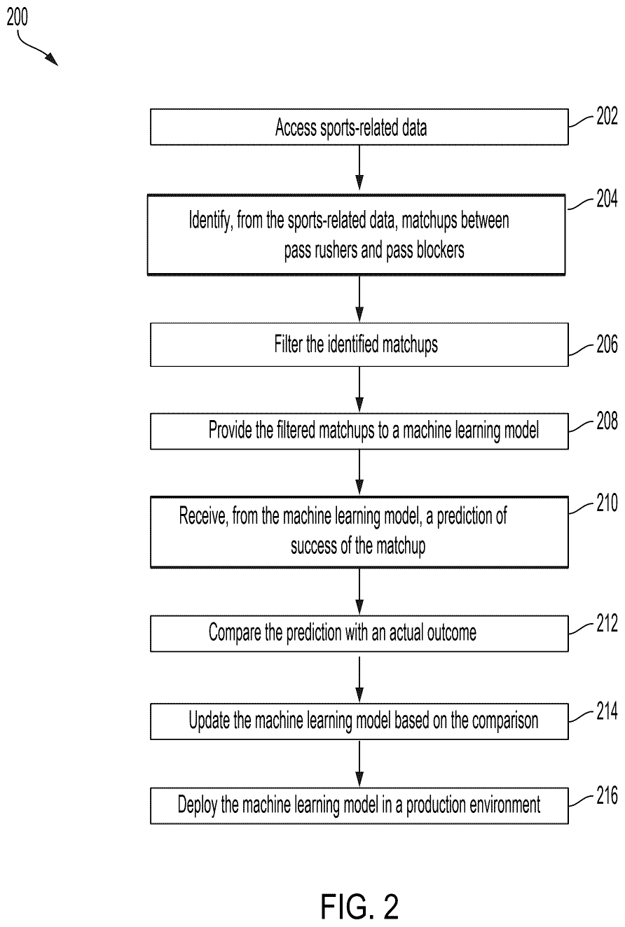

FIG. 2 depicts an example of a method 200 for using machine learning to generate improved sports metrics, in accordance with an aspect. While the discussion below involves computing system 104, predictor 126, and machine learning model 128A for illustrative purposes, method 200 may be implemented on any suitable computing system. Further, while machine learning model 128A is discussed below, certain aspects may employ multiple machine learning models 128A-N. For instance, different machine learning models 128A-N may be used and/or trained for different leagues, teams, or players.

FIG. 2 depicts blocks 202-216. But additional operations may be performed as part of method 200. Further, some blocks of method 200 may be repeated and/or skipped.

In some aspects, before execution of method 200, each player on a team or in a league may be given an initial rating or ranking. In some cases, all players may be given an identical initial rating. As explained below, over time, the ratings change.

At block 202, method 200 may involve accessing tracking data and/or event data. In an example, predictor 126 accesses tracking data and/or event data from data store 118. The tracking data and/or the event data may include matchup information, which may include identifiers of particular players who are matched up, the type of play, the number of minutes into the game, and so forth. Although the method 200 may include one or more of the tracking data and/or the event data, for ease of discussion, the method 200 will be described from here in, in relation to only the tracking data for simplicity.

The data may be tracking data from football competitions, professional or amateur. The data may be from current seasons, previous seasons, or both. In some cases, the sports-related data is derived from analysis of stored video, for example, of archived football games. In other cases, the sports-related data may be obtained and/or processed in real time.

As discussed herein, the tracking data may be a digital representation of players and/or objects (e.g., balls, markers, flags, officials) which may be captured using broadcast feeds and/or in-venue cameras. The digital representations may be generated by identifying one or more players and/or objects and digitizing the player and/or object in a computer-readable space. The digitizing may include identifying a current or predicted location of the player and/or object.

At block 204, method 200 may involve identifying, from the tracking data, one or more matchups between a first player and a second player. The first player may include pass rushers and the second player may include pass blockers, for example. In some examples, the first player may include an offensive player and the second player may include a defensive player, or vice versa. In some examples, the one or more matchups may include the first player and a third player. The one or more matchups may include any number of players as desired. Continuing the example, predictor 126 analyzes the tracking data obtained at block 202 to determine points within the game at which a matchup occurs.

In an example, the matchup may be identified based on proximity detection (e.g., distance thresholds) associated with the tracking data. For example, a predetermined distance threshold may be associated with the tracking data in which it is identified that the first player is a predetermined distance away from the second player indicating that the first player and the second player are on opposing sides. In another example, the matchup may be identified based on formation analysis using machine learning models 128 A-N. For example, the machine learning models 128A-N may be trained with offensive formation input, defensive formation input, or the like. Such training allows the machine learning models 128 A-N to detect or predict movement of the first player and the second player based on the tracking data. In yet another example, the matchup may be identified based on historical analysis of the tracking and/or event data from prior games or in game plays.

For the purposes of this discussion, a matchup is an interaction between a pass rusher and a pass blocker. It is contemplated that other examples may include, but are not limited to: a run blocker, a run defender, a running back, a wide receiver, a defensive back, or the like. At a pass rush, the quarterback is supposed to be (but may not necessarily be) at a particular spot on the field. This analysis may be performed on every passing play. At block 204 predictor 126 may discard data that does not relate to matchups between pass rushers and pass blockers.

At block 206, method 200 may involve filtering the identified matchups. Continuing the example, predictor 126 may filter the identified matchups, creating a subset of matchups. The filtering may be performed based on one or more criteria. The one or more criteria may be received from client device 108 or other system component. For example, the matchups identified at block 204 may be filtered based on a desired play type associated with the one or more criteria. In another example, the matchups identified at block 204 may be filtered to only include matchups between the first player and the second player. In another example, the matchups identified at block 204 may be filtered based on the first player playing a specific team. For instance, the matchups identified at block 204 may be filtered to remove one or more categories of plays such as, for example, run pass options (RPOs). According to this example, a RPO is when the offensive line is run blocking while the quarterback has a pass option.

Other filters may include double teams, chip help from another offensive player, and/or plays where the quarterback releases the ball before a matchup can conclude. These RPO and other matchup related filters are identified and filtered out of the identified matchups. Further, the identified matchups may be filtered if the quarterback does not have enough time in the pocket for the pass rusher and pass protector to complete their matchup.

At block 206, therefore, predictor 126 may discard additional data that does not meet the filter criteria associated with the client device 108. In an example, the discarded additional data may be returned to the data store 118 for later processing. Alternatively, or in addition, the discarded additional data may be deleted from memory associated with predictor 126 for more efficient subsequent computational processing. Alternatively, or in addition, the discarded additional data may be used as input for training for the machine learning models 128 A-N. Such filtering and discarding may reduce the amount of memory required to perform the techniques disclosed herein, resulting in greater computational efficiencies.

At block 208, method 200 may involve providing the filtered matchups to a machine learning model. Continuing the example, predictor 126 provides the filtered matchups generated at block 206 to machine learning model 128A.

Machine learning model 128A may be trained to predict a likelihood of success of a matchup. For instance, machine learning model 128A may predict whether the matchup will result in a win, a loss, or output a probability of either. Different types of machine learning models may be used. Further, the machine learning model may be trained prior to execution of method 200 and/or as part of method 200.

In an example, data associated with each matchup includes an identifier of the offensive player, an identifier of the defensive player, and a binary indication if win or loss. The data may be provided in the form of a feature vector that represents a matchup.

In an aspect, an Elo model may be used. The Elo rating system measures the relative strength of a player compared to other players. For instance, the Elo model may be used to analyse one-on-one matchup results and contextualize them for a strength of competition. Strength of competition may be a particular problem when evaluating players across different conferences in college football. Accordingly, machine learning model 128A may assign a baseline rating for each player at a start of a period (e.g., a season). Then, the model may update a player's rating as the player is matched against other players.

As a season progresses, and teams play other teams, machine learning model 128A improves its capability due to additional data and learning. The machine learning model 128A may be iteratively updated to include tracking data, event data, historical data, or the like across an entirety of a season. In some examples, the machine learning model 128A may be updated on a rolling basis such that the machine learning model 128A may be iteratively retrained based on updated tracking data or event during a game or season such that subsequent outputs are refined based on such updated tracking data or event data. Advantages can include reduced time to stability in the event a new player is introduced given the other player in the matchup is known. For instance, in some cases, after about thirty matchups, or about three games, the system may reach a level of stability. In an example, the machine learning model 128A may include a stability score in which an output of the machine learning model 128A is weighted differently based on a predetermined threshold of the stability score. The stability score may be determined based or a number of instances of available data associated with a player or team, such that a larger number of instances corresponds to a higher stability score. The stability score may be a relative value compared to one or more other players or teams or may be relative to a threshold value for a high stability score (e.g., based on a number of instances determined to be the minimum number of instances for the highest stability score). In an example, a low stability score causes the output of the machine learning model 128A to be weighted less than a high stability score based on the predetermined threshold.

Machine learning model 128A and/or predictor 126 may maintain rankings of individual players among a group of players. For instance, each player may be given an initial rating by machine learning model 128A. The initial level is matched to a “replacement level” player. Before each matchup, machine learning model 128A predicts an outcome based on each player's current rating. Two players with the same rating would be expected to each win 50% of the time. Therefore, the predictions may be updated based on not only a strength of a particular player but a strength of the competition in a particular matchup (e.g., based on a rating output such as an Elo rating output).

Predictor 126 may provide one matchup one at a time or multiple matchups at a time to machine learning model 128A. In an example, the matchups are sorted by least recent to most recent before being provided to the model, one at a time, for separate evaluation.

At block 210, method 200 may involve receiving, from the machine learning model 128A, a prediction of success of the matchup. Continuing the example, predictor 126 receives, from machine learning model 128A, a prediction of success of the matchup such as a predicted win or a predicted loss. In some cases, machine learning model 128A generates a predicted outcome based on each player's current rating before a matchup occurs. For example, two players with the same rating would be expected to each win 50% of the time. In an example, the current rating of the first player may be greater than a current rating of the second player. The difference between the current rating of the first player and the current rating of the second player may be greater than or less than a predetermined threshold. In an example, if the difference between the current rating of the first player and the current rating of the second player is greater than the predetermined threshold, the machine learning model 128A may output a greater likelihood of success (e.g., the first player is likely to win in the matchup). In an example, if the difference between the current rating of the first player and the current rating of the second player is less than the predetermined threshold, the machine learning model 128A may output a lower likelihood of success (e.g., the first player is likely to lose in the matchup).

In some cases, machine learning model 128A may output a binary determination in which zero represents a loss and one represents a win. For example, a win may occur when a defensive linemen gets past the offensive linemen and has an opportunity at the passer's “launch point.” The launch point is typically approximately 8.5 yards directly behind where the ball is snapped, but can change by a yard or two depending on the type of play.

For example, one or more of the identified matchups may be featured on a per-game level at various levels, according to example embodiments. As shown, tracking data and/or event data may be obtained for players and teams from data store 118. The tracking data may help determine which position or positions a player played during the game (e.g., Running Back, Defensive End, Linebacker, Wide Receiver, Center back, Offensive Lineman, Striker, etc.). For example, a first player (Player A) may have played at Defensive End during the game. The position or positions of a player may be identified during the game based on the event data, either in real-time or post-game. Accordingly, for Player A, the predictor 126 may count their contributions at each position separately.

In some embodiments, the prediction of success of the matchup may be updated by a win quality rating. Player ratings may be one way of generating a win quality rating. Elo ratings may be a form of player ratings, however, the present approach should not be limited to the Elo rating. The Elo rating system measures the relative strength of a player compared to other players. For instance, the Elo model may be used to analyse one-on-one matchup results and contextualize them for a strength of competition. Strength of competition may be a particular problem when evaluating players across different conferences in college football. Accordingly, machine learning model 128A may assign a baseline rating for each player at a start of a period (e.g., a season). Then, the model may update a player's rating as the player is matched against other players.

The Elo rating is generated based on one or both of the tracking data and the event data. For example, any type of team rating, such as by human experts, betting markets/predictive markets, and other data-driven team strength ratings may be used in place of or in addition to the Elo rating. Elo ratings may provide a simple approach for updating the prediction of success of a matchup. In some embodiments, the expected result of each matchup, which may be based on the pre-game Elo difference between two players, may be compared to the actual result of the matchup. Based on the difference in expected and actual results, both players may have their Elo rating adjusted.

Using a specific example, given Myles Garrett, his final Elo rating may be represented as a singular number that takes into account his various defensive contributions. For example, the Elo rating assigned to Myles Garrett at the beginning of the season may be the same for all defensive and offensive players, with each player expected to win their individual matchup 50% of the time since the respective players have an equivalent Elo rating. The Elo rating may be adjusted, in real-time or post-game, to account for individual matchup wins and losses. For example, Myles Garrett may have an Elo rating of 1689 during a specified period of time within a game. In a matchup with a player of an Elo rating of 1550, Myles Garrett would be predicted to win said individual matchup 70% of the time. This difference between the players is identified in the win quality rating, which accounts for the difference in Elo ratings of the players during the matchup. The predictor 126 receives the win quality rating and updates the prediction of success of the matchup.

At block 212, method 200 may involve comparing the prediction of success with an actual outcome. Continuing the example, predictor 126 compares the predicted output generated at block 210 with an actual output from the filtered data set obtained at block 206. Predictor 126 may then look at the actual result, compare the actual result to the predicted result, and adjust the ratings for the involved players. For example, the predicted output generated at block 210 may be a matchup rating which may be associated with a success of the matchup. The matchup rating may be represented as a binary score. The actual outcome may be associated with a binary score. When comparing the binary score of the matchup rating to the binary score associated with the actual outcome, the predictor 126 may identify that the binary score of the matchup rating matches the binary score of the actual, indicating that the predictor 126 successfully predicted the outcome of the matchup. The predictor 126 may adjust the ratings of the involved players accordingly. If the binary score of the matchup rating is different than the binary score of the actual outcome within a predetermined threshold, the predictor 126 may not adjust the ratings of the involved players and may identify that the outcome of the present matchup is unknown. This modelling technique creates greater context for the quality of matchups and quicker stabilization of pass rush win rates for new players.

The ratings may be stored and/or generated by machine learning model 128A and/or predictor 126. The ratings may be updated over time, for example, with each iteration of machine learning model 128A. For example, as machine learning model 128A is provided more and more matchup data and is provided feedback based on an accuracy of the generated matchup prediction, the ratings may be adjusted accordingly. Accordingly, blocks 208-212 may be repeated as necessary.

The ratings may be output from machine learning model 128A and/or predictor 126 at any time, for example, on a regular basis or on demand. For example, interim ratings may be obtained and updated each game and then later updated after subsequent matchups. As a season progresses, the rankings may change. The updated rankings based on additional data provide an opportunity for analysis of wins and opportunities as the season progresses. For instance, if a player has ten wins over thirty opportunities, and the wins are largely later in a season, then the system may infer that the player is improving.

At block 214, method 200 may involve updating the machine learning model based on the comparison. Continuing the example, in some cases, the machine learning model may be updated based on the comparisons performed at block 212. For example, the machine learning model may adjust the weighting of the respective inputs based on the comparisons performed at block 212. In other examples, the machine learning model may have its layers, synapses, nodes, biases, etc. adjusted based on the comparisons performed at block 212 to continuously refine the machine learning model. In this manner, the model may improve prediction accuracy over time.

At block 216, method 200 may involve deploying the machine learning model in a runtime or production analytics environment. Data obtained using disclosed techniques may be used for downstream analytics. For example, disclosed systems enable a prediction of future success of a matchup and/or future success of a player. Team ratings may be created for a team based on individual player ratings. Disclosed techniques may also be used to provide analytics prior-to or during a game.

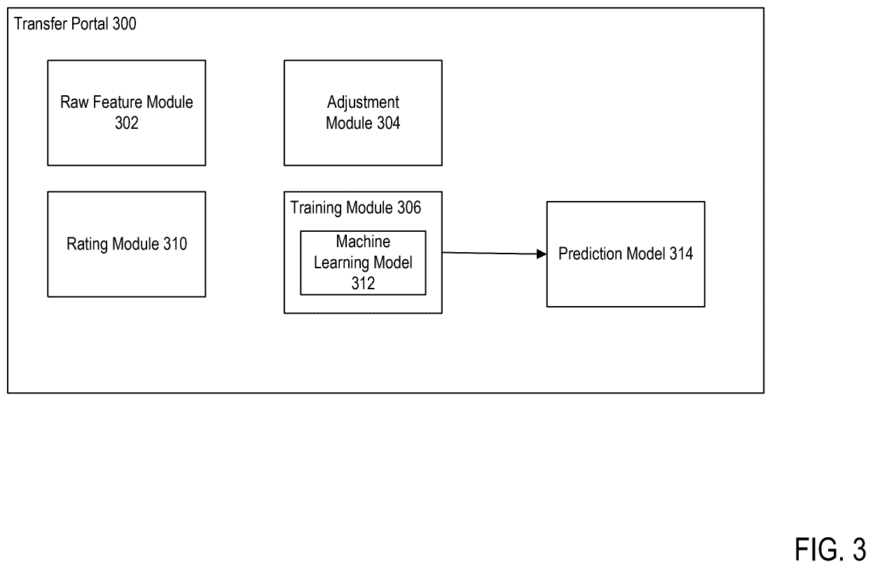

FIG. 3 is a block diagram illustrating transfer portal 300, according to example embodiments. As shown, transfer portal 300 may include a raw feature module 302, an adjustment module 304, and a training module 306. Transfer portal 300 may further include a rating module 310. Rating module 310 may create rating features based on, for example, the Elo statistics. Each of raw feature module 302, adjustment module 304, and training module 306 may be comprised of one or more software modules. The training module 306 may include a machine learning model 312. Once trained, training module 306 may output a fully trained prediction model 314 for deployment. Trained prediction model 314 may be configured to receive a query, such as a proposed trade or acquisition of a player to destination team, and generate a prediction regarding how that player will perform on the destination team, as described with respect to FIG. 5. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Raw feature module 302 may generate aggregate player data per team-position. To do so, raw feature module 302 may aggregate the individual player data for all players of a certain position for each team. For example, raw feature module 302 may aggregate all the tracking and event data for Cleveland Browns's Defensive Lineman (for exemplary purposes, Myles Garrett is being described) to generate raw player data for Defensive Lineman on the Browns. In some embodiments, raw feature module 302 may compute such features using the player data per player-position. Raw feature module 302 may conduct such processes for each position on both teams. In some embodiments, the aggregate generated by raw feature module 302 may be an average (e.g., mean) per 60 minutes across players.

Raw feature module 302 may further compute raw team data while player is in the game features per player-position. To do so, raw feature module 302 may determine event data or tracking data for the team, as a whole, when a particular player is in the game per each position played by the particular feature. For example, raw feature module 302 may determine that the Browns accrued 7 expected sacks while Garrett was on the field and lined up at Defensive End in the game. In some embodiments, raw feature module 302 may further take into consideration how the opposing team performed while a player was in the game. In such embodiments, raw feature module 302 may incorporate offensive metrics into the raw team data while player is in the game. Raw feature module 302 may further generate aggregate raw team data per team in the game. Raw feature module 302 may then store the generated metrics in data store 118.

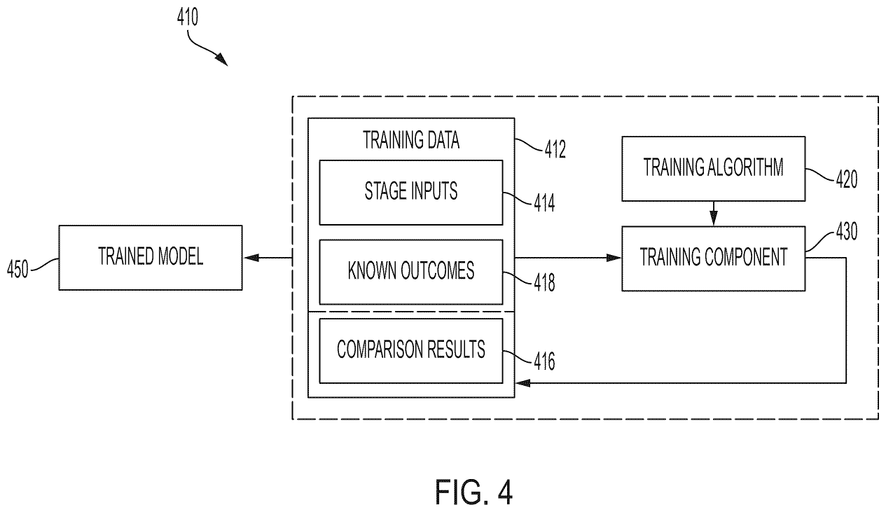

Machine learning model 128A may be trained before use, for example to predict success of a pass rush. An example of updating a machine learning model, e.g., training, is discussed further with respect to FIG. 4.

FIG. 4 depicts a flow diagram for training a machine learning model, in accordance with an aspect. As shown in flow diagram 410 of FIG. 4, training data 412 may include one or more of stage inputs 414 and known outcomes 418 related to a machine learning model to be trained. The stage inputs 414 may be from any applicable source including a component or set shown in the figures provided herein. The known outcomes 418 may be included for machine learning models generated based on supervised or semi-supervised training. An unsupervised machine learning model might not be trained using known outcomes 418. Known outcomes 418 may include known or desired outputs for future inputs similar to or in the same category as stage inputs 414 that do not have corresponding known outputs.

The training data 412 and a training algorithm 420 may be provided to a training component 430 that may apply the training data 412 to the training algorithm 420 to generate a trained machine learning model 450. According to an implementation, the training component 430 may be provided comparison results 416 that compare a previous output of the corresponding machine learning model to apply the previous result to re-train the machine learning model. The comparison results 416 may be used by the training component 430 to update the corresponding machine learning model. The training algorithm 420 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of method 200 may be a trained machine learning model 450.

FIG. 5 depicts a method 500 of generating a player transfer prediction, according to example embodiments. Method 500 may begin at step 502.

At step 502, computing system 104 may receive a request to generate a prediction for transferring a first player to a destination team. The request may indicate one or more of the name or ID of the first player, a name or ID of the current team of the first player, and/or the name or ID of the destination team for the first player.

At step 504, computing system 104 may retrieve a player rating for the first player. For example, predictor 126 may access player ratings of the target player from adjusted player data. Player ratings of the target player may be generated based on raw player position data. For example, player data may capture the most recent X minutes or Y games a player has played at a certain position for a team in a league.

At step 506, computing system 104 may retrieve adjusted team ratings associated with the first player. For example, predictor 126 may access current team data of the target player from adjusted team and team-position input data and access destination team data of the destination team from adjusted input data. This information may be aggregated or combined for future input to predictor 126.

At step 508, computing system 104 may retrieve rating data associated with the first player. For example, predictor 126 may access current team rating data and destination team rating data. In an example, team rating data may be based on player-position input data. The player-position input data may be weighted by position and aggregated into the team rating data.

At step 510, computing system 104 may input the player-position data, the team data, and the rating data to predictor 126. Predictor 126 may analyze the player-position data, the team data, and the rating data to generate a prediction directed to how a player will perform on the destination team.

At step 512, computing system 104 may generate transferred player report. In some embodiments, the transferred player report may include a per game box score prediction that captures how a player will perform on the destination team. Exemplary metrics may include, but are not limited to, expected sacks, pass-rush win rate, run-block win rate, routes run, and the like. The transferred player report may also an include a change in the team rating data of the current team as well as a change in the team rating data of the destination team.

At step 514, the generated transferred player report may be transmitted to the client device 108 or to another downstream entity. The generated transferred player report may be configured to be displayed on the display 110 of the client device 108 or may otherwise be presented to the downstream entity.

For example, the team rating data for the current team (e.g., the Cleveland Browns) may include a team rating of 1316. The team rating data for the destination team (e.g., the Los Angeles Chargers) may include a team rating of 1200. Upon the transfer of the player to the destination team, the team rating of the current team may drop from 1316 to 1271 and the team rating of the destination team may rise from 1200 to 1235.

Disclosed techniques improve over previous solutions. For example, in 2023 an exemplary Pass Rush Win Rate (PRWR) metric saw just two defenders eclipse 30% and only 5 were higher than 25%. This represents 30% of measured opportunities in which the defender “won”. By contest, data obtained with the disclosed techniques suggests that the average win rate in true 1-on-1s is 29.7%, and the best pass rushers have a win rate around 60%.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a football based sports machine learning model may be trained to correlate or otherwise associate player position information in reference to a football field. The football based sports machine learning model may further be trained to correlate or otherwise associate sports data in reference to a number of players and sports targets specific to football.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, the sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

A prediction engine (e.g., which may be part of a tracking data system) may be configured to predict an underlying formation of a team. Mathematically, the goal of a role-alignment procedure may be to find the transformation A: {U₁, U₂, . . . , Uₙ}×M→[R₁, R₂, . . . , R_{K}], which may map the unstructured set U of N player trajectories to an ordered set (e.g., a vector) of K role-trajectories R. Each player trajectory itself may be an ordered set of positions

$${U}_{n} = {[ {x}_{s , n} ]}_{s = 1}^{S}$$

for an agent nϵ[1, N] and a frame sϵ[1, S]. In some embodiments, M may represent the optimal permutation matrix that enables such an ordering. The goal of the prediction engine may be to find the most probable set of [symbol] * of two-dimensional (2D) probability density functions:

$${ℱ}^{*} = arg {max}_{ℱ} P ( ℱ \vert R )$$

$$P ( x ) = {\sum }_{n = 1}^{N} P ( x \vert n ) P ( n ) = \frac{1}{N} {\sum }_{n = 1}^{N} {P}_{n} ( x )$$

In some embodiments, this equation may be transformed into one of entropy minimization where the goal is to reduce (e.g., minimize) the overlap (e.g., the KL-Divergence) between each role. As such, in some embodiments, the final optimization equation in terms of total entropy H may become:

$${ℱ}^{*} = arg {max}_{ℱ} {\sum }_{n = 1}^{N} H ( x \vert n )$$

The prediction engine may include a formation discovery module, a role assignment module, a template module, and/or the like each corresponding to a distinct phase of the prediction process. The formation discovery module may be configured to learn the distributions which maximize the likelihood of the data. The role assignment module may be configured to map each player position to a “role” distribution in each frame. Once the data has been aligned, the template module may be configured to map each learned formation a formation cluster template.

An organization computing system may receive tracking data and/or event data for a plurality of events across a plurality of seasons or across a match. For each event, the pre-processing agent may divide the event into a plurality of segments based on the event information. In some embodiments, the pre-processing agent may divide the event into a plurality of segments based on various events that may occur throughout the game. For example, the pre-processing agent may divide the event into a plurality of segments based on one or more events that include, but may not be limited to, red cards, ejections, technical fouls, flagrant fouls, player disqualifications, substitutions, halves, periods, quarters, overtime, and the like. Generally, each segment of a plurality of segments associated with an event may include an interval of a requisite duration (e.g., at least one minute of play, at least two minutes of play, etc.). Such requisite duration may allow an organization computing system to detect a team's formation.

Each segment may include a set of tracking data associated therewith. The player tracking data may be captured by tracking system, which may be configured to record the (x, y) positions of the players at a high frame rate (e.g., 10 Hz). In some embodiments, the player tracking data may further include single-frame event-labels (e.g., pass, shot, cross) in each frame of player tracking data. These frames may be referred to as “event frames.” As shown, the initial player tracking data may be represented as a set U of N player trajectories. Each player trajectory itself may be an ordered set of positions

$${U}_{n} = {[ {x}_{s , n} ]}_{s = 1}^{S}$$

for an agent nϵ[1, N] and a frame sϵ[1, S].

In some embodiments, the pre-processing agent may normalize the raw position data of the players. For example, the pre-processing agent may normalize the raw position data of the players in each segment so that all teams in the player tracking data are attacking from left to right and have zero mean in each frame. Such normalization may result in the removal of translational effects from the data. This may yield the set U′={U′₁, U′₂, . . . , U″ₙ}.

In some embodiments, the pre-processing agent may initialize cluster centers of the normalized data set for formation discovery with the average player positions. For example, average player positions may be represented by the set μ0={μ₁, μ₂, . . . , μ₃}. The pre-processing agent may take the average position of each player in the normalized data and may initialize the normalized data based on the average player positions. Such initialization of the normalized data based on average player position may act as initial roles for each player to minimize data variance.

An organization computing system may learn a formation template from the tracking data for each segment. For example, the formation discovery module may learn the distributions which maximize the likelihood of the data. The formation discovery module may structure the initialized data into a single (SN)×d vector, where S may represent the total number of frames, N may represent the total number of agents (e.g., ten outfielders in the case of soccer, five players in the case of basketball, fifteen players in the case of rugby, etc.) and d may represent the dimensionality of the data (e.g., d=2).

The formation discovery module may then initiate a formation discovery algorithm. For example, the formation discovery module may initialize a K-means algorithm using the player average positions and execute to convergence. Executing the K-means algorithm to convergence produces better results than conventional approaches of running a fixed number of iterations.

The formation discovery module may then initialize a Gaussian Mixture Model (GMM) using cluster centers of the last iteration of the K-means algorithm. By parametrizing the distribution as a mixture of K Gaussians (with K being equal to the number of “roles,” which is usually also equal to N, the number of players), the formation discovery module may be able to identify an optimal formation that maximizes the likelihood of the data x. In other words, GMM may be configured to identify [symbol] *={P₁, P₂, . . . , P_{K}}, where [symbol] * may represent the optimal formation that maximizes the likelihood of the data x. Therefore, instead of stopping the process after the last iteration of the K-means algorithm, the formation discovery module may use GMM clustering, as the ellipse may better capture the shape of each player role compared to only a K-means clustering technique, which captures the spherical nature of each role's data cloud.

Further, GMMs are known to suffer from component collapse and become trapped in pathological solutions. Such collapse may result in non-sensible clustering, e.g., non-sensical outputs that may not be utilized. To combat this, the formation discovery module may be configured to monitor eigenvalues (λᵢ) of each of the components or parameters of the GMM throughout the expectation maximization process. If the formation discovery module determines that the eigenvalue ratio of any component becomes too large or too small, the next iteration may run a Soft K-Means (e.g., a mixture of Gaussians with spherical covariance) update instead of the full-covariance update. Such process may be performed to ensure that the eventual clustering output is sensible. For example, the formation discovery module may monitor how the parameters of the GMM are converging; if the parameters of the GMM are erratic (e.g., “out of control”), the formation discovery module may identify such erratic behavior and then slowly return the parameters back within the solution space using a soft K-means update.

### Hash-Table/Playbook Learning

For retrieval tasks using large amounts of data, an embodiment of the system uses a hash-table is required by grouping similar plays together, such that when a query is made, only the “most-likely” candidates are retrieved. Comparisons can then be made locally amongst the candidates and each play in these groups are ranked in order of most similar. Previous systems attempted clustering plays into similar groups by using only one attribute, such as the trajectory of the ball. However, the semantics of a play are more accurately captured by using additional information, such as information about the players (e.g., identity, trajectory, etc.) and events (pass, dribble, shot, etc.), as well as contextual information (e.g., if team is winning or losing, how much time remaining, etc.). Thus, embodiments of the present system utilize information regarding the trajectories of the ball and the players, as well as game events and contexts, to create a hash-table, effectively learning a “playbook” of representative plays for a team or player's behavior. The playbook is learned by choosing a classification metric that is indicative of interesting or discriminative plays. Suitable classification metrics may include predicting the probability of scoring in soccer or basketball (e.g., expected point value (“EPV”), or expected goal value (“EGV”). Other predicted values can also be chosen for performance variables, such as probability of making a pass, probability of shooting, probability of moving in a certain direction/trajectory, or the probability of fatigue/injury of a player.

The classification metric is used to learn a decision-tree, which is a coarse-to-fine hierarchical method, where at each node a question is posed which splits the data into groups. A benefit of this approach is that it can be interpretable and is multi-layered, which can act as “latent factors.”

### Bottom-Up Approach

In an embodiment of the system, a bottom-up approach to learning the decision tree is used. Various features are used in succession to discriminate between plays (e.g., first use the ball, then the player who is closest to the ball, then the defender etc.). By aligning the trajectories, there is a point of reference for trajectories relative to their current position. This permits more specific questions while remaining general (e.g., if a player is in the role of “point guard”, what is the distance from his/her teammate in the role of “shooting guard”, as well as the distance from the defender in the role of “point guard”). Using this approach avoids the need to exhaustively check all distances, which is enormous for both basketball and soccer.

### Top-Down Approach

In another embodiment of the system, a top-down approach to learning the decision tree is used. At a first step, all the plays are aligned to the set of templates. From this initial set of templates, the plays are assigned to a set of K groups (clusters), using all ball and player information, forming a Layer 1 of the decision tree. Back propagation is then used to prune out unimportant players and divide each cluster into sub-clusters (Layer 2). The approach continues until the leaves of the tree represent a dictionary of plays which are predictive of a particular task—e.g., goal-scoring (Layer 3).

Personalization using Latent Factor Models

In addition to raw trajectory information, in embodiments of the system, the plays in the database are also associated with game event information and context information. The game events and contexts in the database for a play may be inferred directly from the raw positional tracking data (e.g., a made or missed basket), or may be manually entered. Role information for players (can also be either inferred from the positional tracking data or entered separately. In embodiments of the system, a model for the database can then be trained by crafting features which encode game specific information based on the positional and game data and then calculating a prediction value (between 0 and 1) with respect to a classification metric (e.g., expected point value).

If there are a sufficient number of examples, the database model can be personalized for a particular player or game situation using those examples. In practice, however, a specific player or game situation may not be adequately represented by plays in the database. Thus, embodiments of the system find examples which are similar to the situation of interest-whether that be finding players who have similar characteristics or teams who play in a similar manner. A more general representation of a player and/or team is used, whereby instead of using the explicit team identity, each player or team is represented as a distribution of specific attributes. Embodiments of the system use the plays in the hash-table/playbook that were learned through the distributive clustering processes described above.

Further, while various aspects are discussed with respect to a single sport, such aspects are described are merely illustrative examples. Disclosed techniques are by no means limited to any sport in particular. For example, the present aspects can be implemented for other sports or activities, such as soccer, football, basketball, baseball, hockey, cricket, rugby, tennis, and so forth.

According to embodiments disclosed herein, a transformer neural network may receive inputs (e.g., tensor layers), where each input corresponds to a given player, team, or game. The transformer neural network may output generated predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events, and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacency matrix defining the edges between the nodes (the absence of an attention mask thus implies a fully-connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (i.e. attend to): the nodes containing the previous states of the player along the time-series; and the state nodes of the other players, team and the current game state in the current time-step. It may not be necessary for the nodes to be homogeneous—beyond having the same feature dimension—and thus a node that represents a player can accept messages from a node that represents at team, or from the player's strength node. The model may therefore learn the interactions between agents, and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics such as number of shots taken, number of goals, number of passes, etc.

The training of the transformer-based neural network may include choosing a corresponding loss function for the distribution assumption of each output target. For example, the loss function may be the Poisson negative log-likelihood for a Poisson distribution, binary cross entropy for a Bernouilli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

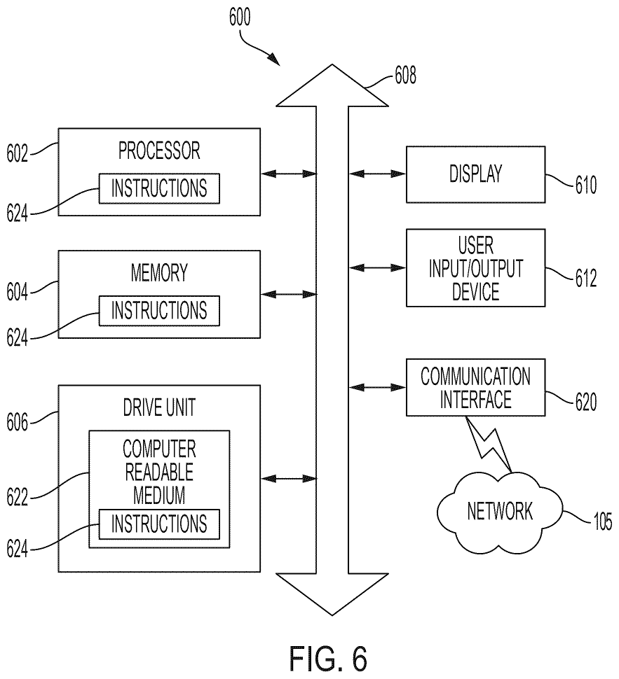

FIG. 6 is a simplified functional block diagram of a computer 600 that may be configured as a device for executing the methods disclosed here, according to exemplary aspects of the present disclosure. For example, the computer 600 may be configured as a system according to exemplary aspects of this disclosure. In various aspects, any of the systems herein may be a computer 600 including, for example, a data communication interface 620 for packet data communication. The computer 600 also may include a central processing unit (“CPU”) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications.

The computer 600 may also have a memory 604 (such as RAM) storing instructions 624 for executing techniques presented herein, for example method 200, although the instructions 624 may be stored temporarily or permanently within other modules of computer 600 (e.g., processor 602 and/or computer readable medium 622). The computer 600 also may include input and output ports 612 and/or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol. Additionally, while this discussion is focused on American football, it is contemplated that the disclosed aspects may be applied for any sport.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for using machine learning to predict a success of a matchup in a sporting event, the method comprising:
accessing tracking data from a data store;
identifying, from the tracking data, one or more matchups wherein each matchup comprises an identification of a first player, an identification of a second player, and a success of a corresponding outcome;
filtering the identified matchups to create a subset of matchups;
providing the subset of matchups to a trained machine learning model;
receiving, from the machine learning model, a prediction of success of the matchup;
comparing the prediction of success with a measured outcome; and
adjusting a ranking of the first player, a ranking of the second player, and/or the machine learning model based on the prediction.

2. The method of claim 1, wherein filtering the identified matchups is based on one or more criteria associated with the identified matchups.

3. The method of claim 2, wherein the one or more criteria is associated with a client device.

4. The method of claim 2, wherein the trained machine learning model discards tracking data not associated with the identified matchups.

5. The method of claim 1, wherein the ranking of the first player includes a first Elo rating and the second ranking of the second player includes a second Elo rating.

6. The method of claim 5, wherein a win quality rating is generating based on a difference between the first Elo rating of the first player and the second Elo rating of the second player.

7. The method of claim 1, wherein the adjusted ranking of the first player is used in generation of a prediction of performance on a destination team.

8. A non-transitory computer readable medium having a sequence of instructions, which, when executed by a processor, causes a computing system to perform operations comprising:
accessing, by the computing system, tracking data from a data store;
identifying, via the computing system from the tracking data, one or more matchups wherein each matchup comprises an identification of a first player, an identification of a second player, and a success of a corresponding outcome;
filtering, by the computing system, the identified matchups to create a subset of matchups;
providing, by the computing system, the subset of matchups to a trained machine learning model;
receiving, by the computing system from the machine learning model, a prediction of success of the matchup;
comparing, by the computing system, the prediction of success with a measured outcome; and
adjusting, by the computing system, a ranking of the first player, a ranking of the second player, and/or the machine learning model based on the prediction.

9. The non-transitory computer readable medium of claim 8, wherein filtering the identified matchups is based on one or more criteria associated with the identified matchups.

10. The non-transitory computer readable medium of claim 9, wherein the one or more criteria is associated with a client device.

11. The non-transitory computer readable medium of claim 9, wherein the trained machine learning model discards tracking data not associated with the identified matchups.

12. The non-transitory computer readable medium of claim 8, wherein the ranking of the first player includes a first Elo rating and the second ranking of the second player includes a second Elo rating.

13. The non-transitory computer readable medium of claim 12, wherein a win quality rating is generating based on a difference between the first Elo rating of the first player and the second Elo rating of the second player.

14. The non-transitory computer readable medium of claim 8, wherein the adjusted ranking of the first player is used in generation of a prediction of performance on a destination team.

15. A computing system comprising:
a processor implemented in hardware; and
a memory having programming instructions stored thereon, which, when executed by the processor, causes the system to perform operations comprising:
accessing tracking data from a data store;
identifying, from the tracking data, one or more matchups wherein each matchup comprises an identification of a first player, an identification of a second player, and a success of a corresponding outcome;
filtering the identified matchups to create a subset of matchups;
providing the subset of matchups to a trained machine learning model;
receiving, from the machine learning model, a prediction of success of the matchup;
comparing the prediction of success with a measured outcome; and
adjusting a ranking of the first player, a ranking of the second player, and/or the machine learning model based on the prediction.

16. The system of claim 15, wherein filtering the identified matchups is based on one or more criteria associated with the identified matchups.

17. The system of claim 16, wherein the one or more criteria is associated with a client device.

18. The system of claim 16, wherein the trained machine learning model discards tracking data not associated with the identified matchups.

19. The system of claim 15, wherein the ranking of the first player includes a first Elo rating and the second ranking of the second player includes a second Elo rating.

20. The system of claim 19, wherein a win quality rating is generating based on a difference between the first Elo rating of the first player and the second Elo rating of the second player.
